(19) United States
(12) Patent Application Publication
(10) Pub. No.: US 2005/0134548 A1
(43) Pub. Date: Jun. 23, 2005

(54) Display apparatus and method of driving the same

(75) Inventors: Jin-Hong Kim, Seoul (KR); Cheol-Woo Park, Suwon-si (KR); Chong-Chul Chai, Seoul (KR); Kyoung-Ju Shin, Yongin-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/949,068

(22) Filed: Sep. 24, 2004

(30) Foreign Application Priority Data
Dec. 19, 2003 (KR) 2003-93836

(51) Int. Cl. G09G 3/36

(52) U.S. Cl. 345/102

(57) ABSTRACT

A light generating part generates a first light based on a first control signal. A first driving part outputs a panel driving signal. A display panel receives the first light or a second light that is provided from an exterior to display an image based on the panel driving signal. A sensing part outputs a sensing signal based on the second light. A second driving part compares a reference voltage range with the sensing signal to output the first control signal. The reference voltage range is determined by a first reference voltage and a second reference voltage. Therefore, the light generating part is turned on/off based on the second light to decrease the power consumption of the light generating part, and an operation of the light generating part is stabilized.

### CROSS-REFERENCE OF RELATED APPLICATIONS

The present application claims priority from Korean Patent Application No. 2003-93836, filed on Dec. 19, 2003, the disclosure of which is hereby incorporated herein by reference in its entirety.

### BACKGROUND OF THE INVENTION

1. Field of the Invention

The present invention relates to a display apparatus and a method of driving the display apparatus. More particularly, the present invention relates to a display apparatus capable of controlling an operation of a light generating part and reducing power consumption thereof and a method of driving the display apparatus.

2. Description of the Related Art

A display apparatus, generally, includes a display panel displaying an image using a light. The light may be an externally provided light such as a sunlight, an illumination light, etc., or an internally provided light generated from a backlight, a front-light, etc.

The display apparatus displays the image using the externally provided light and the internally provided light. The display apparatus displays the image using the externally provided light in a bright place, and displays the image using the internally provided light in a dark place.

A power consumption of the backlight assembly may be about 70% of the power consumption of the display apparatus. A backlight assembly having low power consumption is in demand for a portable display device such as a cellular phone, a notebook computer, personal digital assistants (PDA), etc.

When the power consumption of the backlight assembly decreases, the amount of the light generated from the backlight assembly also decreases, thereby decreasing luminance of the display apparatus.

### BRIEF SUMMARY OF THE INVENTION

The present invention provides a display apparatus capable of controlling an operation of a light generating part and reducing power consumption thereof.

The present invention also provides a method of driving the above-mentioned display apparatus.

A display apparatus in accordance with one exemplary embodiment of the present invention includes a light generating part, a first driving part, a display panel, a sensing part and a second driving part. The light generating part generates a first light based on a first control signal. The first driving part outputs a panel driving signal. The display panel is disposed on the light generating part to receive the first light that is generated from the light generating part or a second light that is provided from an exterior to display an image based on the panel driving signal. The sensing part is disposed on the display panel to output a sensing signal based on the second light that is provided from an exterior to the display panel. The second driving part is disposed between the sensing part and the light generating part to compare a reference voltage range with the sensing signal to output the first control signal. The voltage range is determined based on a first reference voltage and a second reference voltage higher than the first reference voltage.

A method of manufacturing in accordance with one exemplary embodiment of the present invention is provided. A first light is generated based on a control signal. A panel driving signal is outputted. The first light or a second light is received to display an image based on the panel driving signal. The second light is provided from an exterior to display an image. A sensing signal is outputted based on the second light. The sensing signal is compared with a first reference level and a second reference level higher than the first reference level to output the control signal. The first and second reference levels determine a voltage reference range.

Therefore, the light generating part is turned on/off based on the amount of the second light to decrease the power consumption of the light generating part. In addition, number of the turning on/off is decreased to stabilize the operation of the light generating part.

### BRIEF DESCRIPTION OF THE DRAWINGS

The above and other advantages of the present invention will become more apparent by describing in detail exemplary embodiments thereof with reference to the accompanying drawings, in which:

FIG. 1 is a block diagram showing a display apparatus according to an exemplary embodiment of the present invention;

FIG. 2 is a plan view showing a liquid crystal display (LCD) apparatus according to an exemplary embodiment of the present invention;

FIG. 3 is a cross-sectional view taken along the line I-I′ shown in FIG. 2;

FIG. 4 is a circuit diagram showing an LCD apparatus according to an exemplary embodiment of the present invention;

FIG. 5 is a circuit diagram showing a light sensing part according to an exemplary embodiment of the present invention;

FIG. 6 is a timing diagram showing an output signal of a gate driving integrated circuit (IC) and a light sensing part according to an exemplary embodiment of the present invention;

FIG. 7 is a block diagram showing a second driving part according to an exemplary embodiment of the present invention;

FIG. 8 is a circuit diagram showing a first comparator and a second comparator; and

FIG. 9 is a timing diagram showing an output signal of a second driving part according to an exemplary embodiment of the present invention.

### DESCRIPTION OF THE EMBODIMENTS

Hereinafter, the embodiments of the present invention will be described in detail with reference to the accompanying drawings.

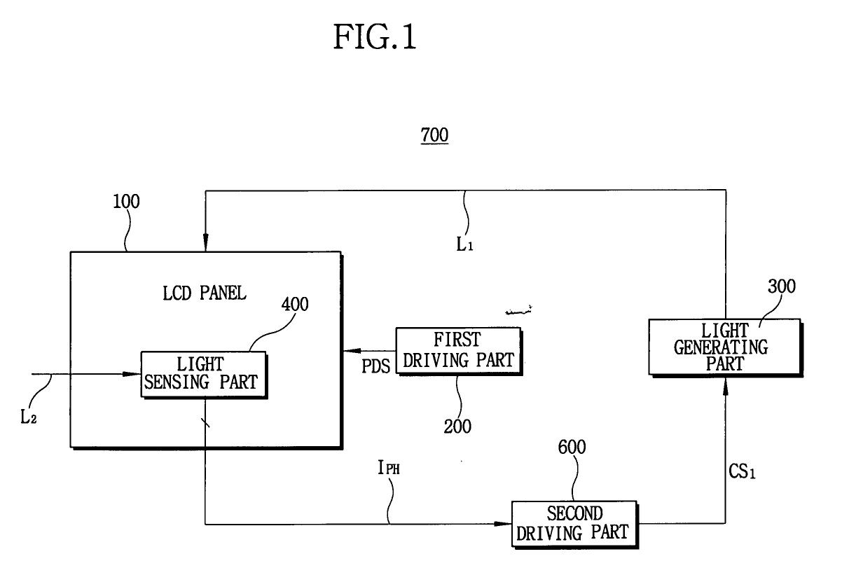

FIG. 1 is a block diagram showing a display apparatus according to an exemplary embodiment of the present invention.

Referring to FIG. 1, the liquid crystal display (LCD) apparatus 700 includes an LCD panel 100 displaying an image, a first driving part 200 outputting a panel driving signal PDS that drives the LCD panel 100, a light generating part 300 supplying the LCD panel 100 with an internally provided light L₁ and a second driving part 600 driving the light generating part 300.

The LCD panel 100 includes a light sensing part 400 outputting a photo current Iₚₕ based on an amount of an externally provided light L₂ that is supplied from an exterior to the LCD panel 100. The second driving part 600 outputs a first control signal CS₁ driving the light generating part 300 based on the photo current Iₚₕ outputted from the light sensing part 400.

When the externally provided light L₂ is insufficient to display the image, the light sensing part 400 outputs the photo current Iₚₕ based on the insufficient externally provided light L₂ so that the second driving part 600 outputs the first control signal corresponding to the insufficient externally provided light L₂. Therefore, the light generating part 300 generates the internally provided light L₁ based on the first control signal CS₁ corresponding to the insufficient externally provided light L₂ so that the LCD panel 100 displays an image using the internally and externally provided lights L₁ and L₂.

When the externally provided light L₂ is sufficient to display the image, the light sensing part 400 outputs the photo current Iₚₕ based on the sufficient externally provided light L₂ so that the second driving part 600 outputs the first control signal corresponding to the sufficient externally provided light L₂. Therefore, the light generating part 300 does not generate the internally provided light L₁ based on the first control signal CS₁ corresponding to the sufficient externally provided light L₂ so that the LCD panel 100 displays the image using the externally provided light L₂.

The LCD apparatus 700 turns on/off the light generating part 300 based on a variation of the amount of the externally provided light L₂. Therefore, a power consumption of the LCD apparatus 700 is decreased. In addition, the LCD apparatus 700 may display the image of an improved display quality in a dark place although the power consumption of the LCD apparatus 700 is decreased.

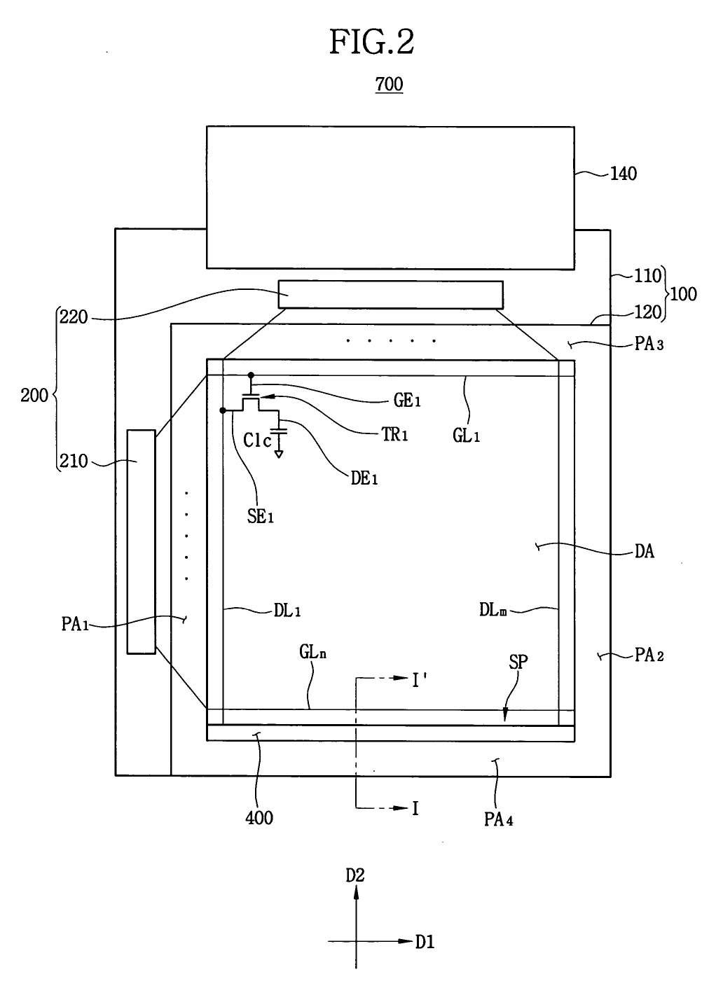

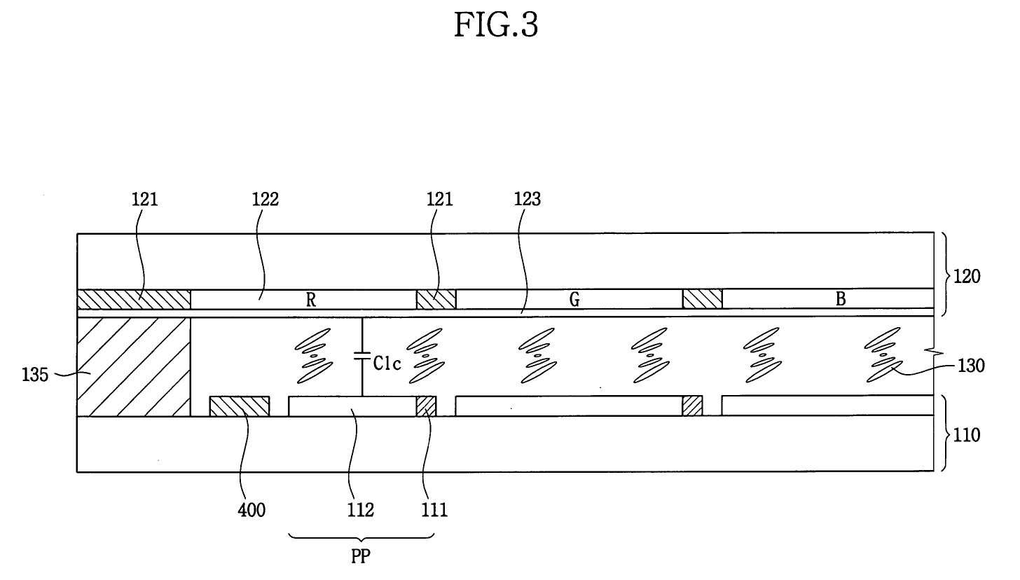

FIG. 2 is a plan view showing a liquid crystal display (LCD) apparatus according to an exemplary embodiment of the present invention, and FIG. 3 is a cross-sectional view taken along the line I-I′ shown in FIG. 2.

Referring to FIGS. 2 and 3, the LCD panel 100 includes a lower substrate 110, an upper substrate 120 corresponding to the lower substrate 110, a liquid crystal layer 130 interposed between the lower and upper substrates 110 and 120, and a sealant 135.

The LCD panel 100 includes a display area DA where the image is displayed and first to fourth peripheral areas PA₁, PA₂, PA₃ and PA₄ are disposed at a position adjacent to the display area DA.

The upper substrate 120 includes a blocking layer 121, a color filter 122 and a common electrode 123.

The color filter 122 includes a red color filter unit corresponding to a red color, a green color filter unit corresponding to a green color and a blue color filter unit corresponding to a blue color. The blocking layer 121 is disposed between the color filter units in the display area DA to improve the display quality of the LCD apparatus 700. In addition, the blocking layer 121 is also disposed in a position corresponding to the first to fourth peripheral areas PA₁, PA₂, PA₃ and PA₄. The common electrode 123 is uniformly formed in thickness on the blocking layer 121 and the color filter 122.

A plurality of pixel portions PP is arranged in a matrix shape on the lower substrate 110 corresponding to the display area DA. The pixel portions PP are defined by a plurality of gate lines GL₁, GL₂, . . . GLₙ extended in a first direction D₁ and a plurality of data lines DL₁, DL₂, . . . DLₙ extended in a second direction D₂.

Each of the pixel portions PP includes a pixel thin film transistor TR₁ and a pixel electrode PE. The pixel thin film transistor TR₁ includes a first gate electrode GE₁ electrically connected to one of the gate lines, a first source electrode SE₁ electrically connected to one of the data lines, and a first drain electrode DE1 electrically connected to the pixel electrode PE. The pixel electrode PE corresponds to the common electrode 123, and the liquid crystal layer 130 is disposed between the pixel electrode PE and the common electrode 123 to form a liquid crystal capacitor Clc.

The first peripheral area PA₁ is disposed at a position adjacent to first end portions of the gate lines GL₁, GL₂, . . . GLₙ, and the second peripheral area PA₂ is disposed at a position adjacent to the second end portions of the gate lines GL₁, GL₂, . . . GLₙ corresponding to the first end portions. The third peripheral area PA₃ is also disposed at a position adjacent to the third end portions of the data lines DL₁, DL₂, . . . DLₘ, and the fourth peripheral area PA₄ is disposed at a position adjacent to the fourth end portions of the data lines DL₁, DL₂, . . . DLₘ corresponding to the third end portions.

The first driving part 200 driving the LCD panel 100 includes a gate driving integrated circuit 210 disposed in the first peripheral area PA₁ and a data driving integrated circuit 220 disposed in the third peripheral area PA₃.

The gate driving integrated circuit 210 is electrically connected to the first end portions of the gate lines GL₁, GL₂, . . . GLₙ in the first peripheral area PA₁ to successively output gate signals to the gate lines GL₁, GL₂, . . . GLₙ. Alternatively, the gate driving integrated circuit 210 may include amorphous silicon so that the gate driving integrated circuit 210 is formed in the first peripheral area PA₁ of the lower substrate 110. Alternatively, the gate driving integrated circuit 210 may be directly formed on the lower substrate 110. The gate driving integrated circuit 210 may also be formed in one of the first to fourth peripheral areas PA₁, PA₂, PA₃ and PA₄. The gate driving integrated circuit 210 may also be formed from a same layer as the thin film transistors. When the gate driving integrated circuit 210 is formed in one of the first to fourth peripheral areas PA₁, PA₂, PA₃ and PA₄, a center of the display area DA may be disposed at a center of the LCD panel 100. The data driving integrated circuit 220 is electrically connected to the third end portions of the data lines DL₁, DL₂, . . . DLₘ in the third peripheral region PA₃ to output data signals to the data lines DL₁, DL₂, . . . DLₘ. Alternatively, the gate driving integrated circuit 210 and the data driving integrated circuit 220 may form a one chip.

The light sensing part 400 is disposed in a side portion SP of the display area DA adjacent to the fourth peripheral area PA₄. The light sensing part 400 outputs the photo current Iₚₕ based on the amount of the externally provided light L₂ that is provided from an exterior to the LCD panel 100. The photo current Iₚₕ varies in proportion to the amount of the externally provided light L₂. That is, the photo current Iₚₕ increases when the amount of the externally provided light L₂ increases. The photo current Iₚₕ decreases when the amount of the externally provided light L₂ decreases. Alternatively, the sensing part 400 may include amorphous silicon. The light sensing part 400 may be directly formed on the lower substrate 110, and the light sensing part 400 may be formed from the same layer as the thin film transistors, the gate lines, the data lines, etc. so that a manufacturing process of the LCD panel 100 may be simplified.

The data driving integrated circuit 220 is electrically connected to the third end portions of the data lines DL₁, DL₂, . . . DLₘ. The fourth end portions of the data lines DL₁, DL₂, . . . DLₘ are disposed in the display area DA so that the fourth end portions of the data lines DL₁, DL₂, . . . DLₘ are not disposed in the fourth peripheral area PA₄. Therefore, the light sensing part 400 may not overlapped with the data lines DL₁, DL₂, . . . DLₘ though the light sensing part 400 is disposed in the side portion SP of the display area DA. When the light sensing part 400 is not overlapped with the data lines DL₁, DL₂, . . . DLₘ, the gate or data signals that are applied to the display area DA may not be distorted.

A flexible circuit board 140 is disposed in the third peripheral area PA₃. The flexible circuit board 140 receives signals from an exterior to the LCD panel to apply the gate driving integrated circuit 210, the data driving integrated circuit 220 and the light sensing part 400 with the signals.

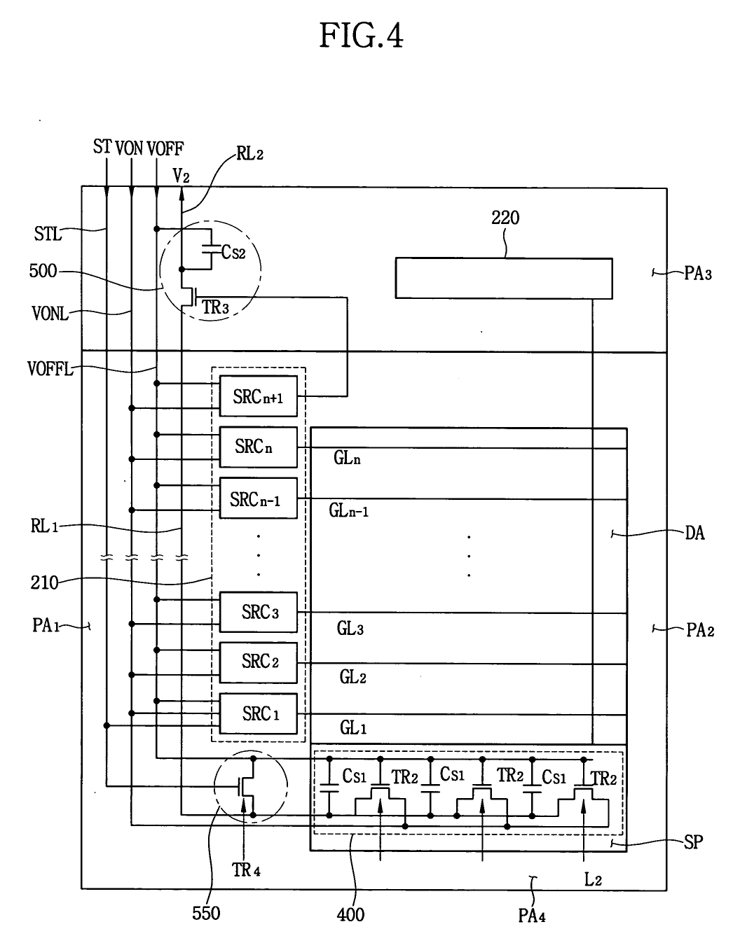

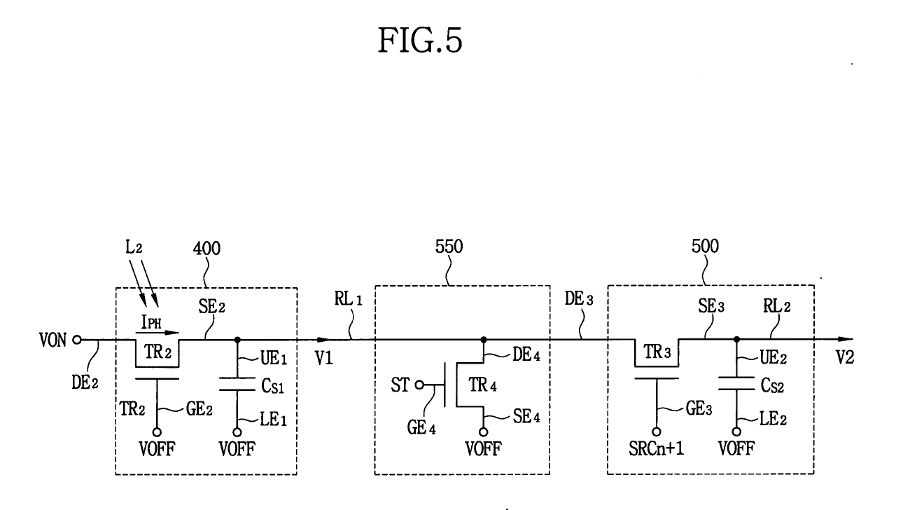

FIG. 4 is a circuit diagram showing an LCD apparatus according to an exemplary embodiment of the present invention, and FIG. 5 is a circuit diagram showing a light sensing part according to an exemplary embodiment of the present invention.

Referring to FIG. 4, the light sensing part 400 is disposed in the side portion SP of the display area DA. The gate driving integrated circuits 210 and data driving integrated circuit 220 are disposed in the first and third peripheral areas PA₁ and PA₃, respectively. The first and third peripheral areas PA₁ and PA₃ are disposed at a position adjacent to the display area DA.

The gate driving integrated circuit 210 includes a shift resistor having a plurality of stages SRC₁, SRC₂, . . . , SRCₙ₊₁. A plurality of gate lines GL₁, GL₂, . . . GLₙ is electrically connected to the stages SRC₁, SRC₂, . . . , SRCₙ so that the stages SRC₁, SRC₂, . . . , SRCₙ apply the gate signals to the gate lines GL₁, GL₂, . . . GLₙ, respectively.

A last stage SRCₙ₊₁ of the stages SRC₁, SRC₂, . . . SRCₙ₊₁ is a dummy stage that drives an n-th stage SRCₙ.

A first driving voltage line VONL and a second driving voltage line VOFFL are extended in the first direction D₁, and are disposed in the first peripheral area PA₁ adjacent to the gate driving integrated circuit 210. A start signal ST is applied to the first stage SRC₁ through the start signal line STL. The start signal line STL is disposed at a position adjacent to the first driving voltage line VONL.

Referring to FIGS. 4 and 5, the light sensing part 400 includes a plurality of sensing thin film transistors TR₂ and a plurality of first storage capacitors Cₛ₁.

Each of the sensing thin film transistors TR₂ includes a second gate electrode GE₂ electrically connected to the second driving voltage line VOFFL, a second drain electrode DE₂ electrically connected to the first driving voltage line VONL and a second source electrode SE₂ electrically connected to a first read-out line RL₁. Each of the first storage capacitors Cₛ₁ includes a first electrode LE₁ electrically connected to the second driving voltage line VOFFL and a second electrode UE₁ electrically connected to the first read-out line RL₁.

A read-out part 500 is disposed in the third peripheral area PA₃. The read-out part 500 includes a read-out thin film transistor TR₃ and a second storage capacitor Cₛ₂. The read-out thin film transistor TR₃ includes a third gate electrode GE₃ electrically connected to an output terminal of the last stage SRCₙ₊₁, a third drain electrode DE₃ electrically connected to the first read-out line RL₁ and a third source electrode SE₃ electrically connected to the second read-out line RL₂. The second storage capacitor Cₛ₂ includes a third electrode LE₂ electrically connected to the second driving voltage line VOFFL and a fourth electrode UE₂ electrically connected to the second read-out line RL₂.

A reset part 550 is disposed in the first peripheral region PA₁. The reset part 550 may initialize the sensing part 400 at every predetermined interval. A reset thin film transistor TR₄ of the reset part 550 includes a fourth gate electrode GE₄ electrically connected to the start signal line STL, a fourth drain electrode DE₄ electrically connected to the first read-out line RL₁ and a fourth source electrode SE₄ electrically connected to the second driving voltage line VOFFL.

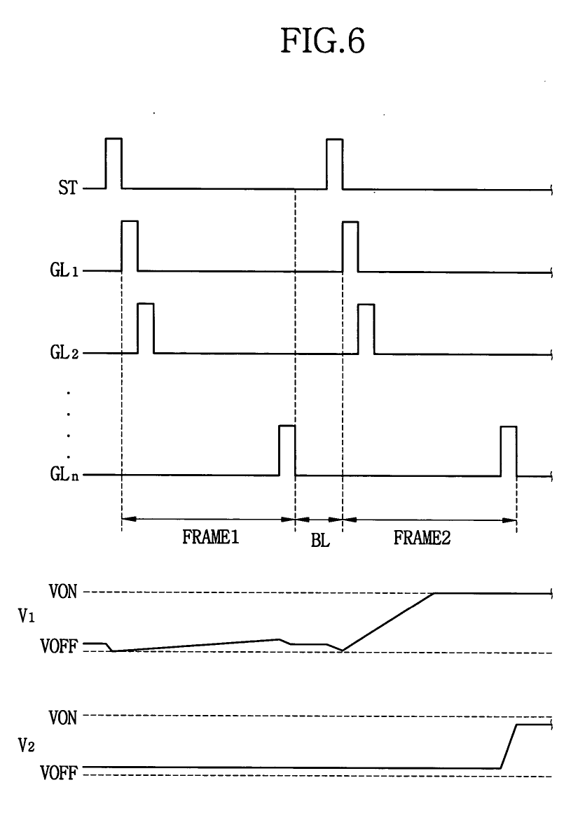

FIG. 6 is a timing diagram showing an output signal of a gate driving integrated circuit (IC) and a light sensing part according to an exemplary embodiment of the present invention.

Referring to FIG. 6, when the start signal ST is applied to the first stage SRC₁ during a first frame, the first stage SRC₁ applies a first gate signal to the first gate line GL₁.

Subsequently, the second stage SRC₂ outputs a second gate signal to the second gate line GL₂ based on the first gate signal outputted from the first stage SRC₁. The above described processes are repeated so that the gate signals are applied to the gate lines GL₁, GL₂, . . . GLₙ, respectively, during the first frame.

The start signal ST is then applied to the first stage SRC₁ to start a second frame. The above described processes are repeated so that the gate signals are applied to the gate lines GL₁, GL₂, . . . GLₙ, respectively, during the second frame.

A blank period BL is interposed between the first and second frames. The gate signals applied to the gate lines GL₁, GL₂, . . . GLₙ, are discharged during the blank period BL so as to initialize the gate lines GL₁, GL₂, . . . GLₙ.

The sensing thin film transistor TR₂ outputs the photo current Iₚₕ to the second source electrode SE₂ based on the externally provided light L₂. The first storage capacitor Cₛ₁ receives the photo current Iₚₕ that is outputted from the sensing thin film transistor TR₂.

When the amount of the externally provided light L₂ decreases, the photo current Iₚₕ outputted from the sensing thin film transistor TR₂ also decreases so that a first voltage V₁ charged in the first storage capacitor Cₛ₁ decreases based on the decreased photo current Iₚₕ. Therefore, the first voltage V₁ is slightly higher than the second driving voltage VOFF during the first frame.

The read-out transistor TR₃ is then turned on based on the output signal outputted from the last stage SRCₙ₊₁. The read-out thin film transistor TR₃ reads the first voltage V₁ stored in the first storage capacitor Cₛ₁ so that the second storage capacitor Cₛ₂ receives a second voltage V₂ based on the first voltage V₁.

The first voltage V₁ stored in the first storage capacitor Cₛ₁ is discharged during the blank period BL to form the second driving voltage VOFF.

When the amount of the externally provided light L₂ increases, the photo current lₚₕ outputted from the sensing thin film transistor TR₂ increases. Therefore, the first voltage V₁ charged in the first storage capacitor Cs₁ based on the increased photo current Iₚₕ also increases to the first driving voltage VON.

The read-out thin film transistor TR₃ is then turned on based on the output signal outputted from the last stage SRCₙ₊₁. Therefore, the read-out thin film transistor TR₃ reads the first voltage V₁ stored in the first storage capacitor Cₛ₁ so that the second storage capacitor Cₛ₂ receives the second voltage V₂ based on the first voltage V₁.

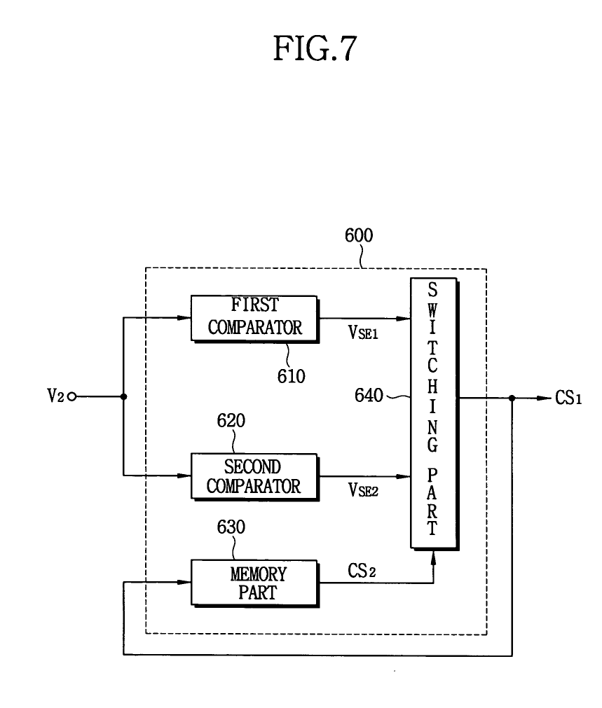

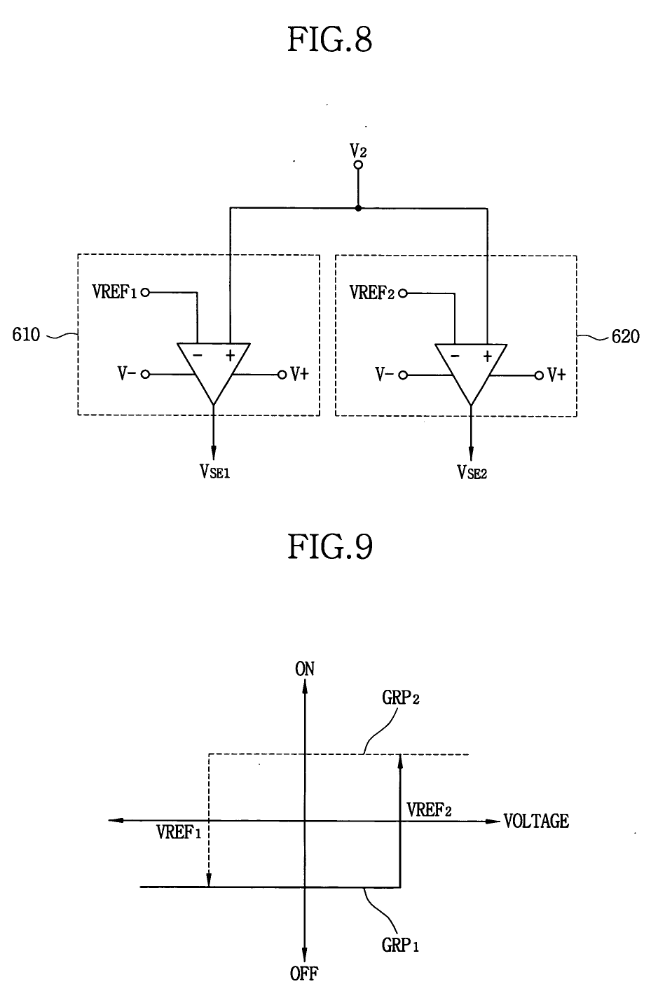

FIG. 7 is a block diagram showing a second driving part according to an exemplary embodiment of the present invention, and FIG. 8 is a circuit diagram showing a first comparator and a second comparator.

Referring to FIGS. 7 and 8, the second driving part 600 includes a first comparator 610, a second comparator 620, a memory part 630 and a switching part 640.

The first comparator 610 receives the second voltage V₂ outputted from the read-out part 500, and includes a first operational amplifier OP-AMP that compares the second voltage V₂ with a first reference voltage VREF₁ to output a first state voltage V_{SE1}. The first reference voltage VREF₁ is a minimum voltage of a reference voltage range. When the second voltage V₂ is higher than the first reference voltage VREF₁, the first state voltage V_{SE1} has a first voltage level V+. When the second voltage V₂ is lower than the first reference voltage VREF₁, the first state voltage V_{SE1} has a second voltage level V−.

The second comparator 620 receives the second voltage V₂ outputted from the read-out part 500, and includes a second operational amplifier OP-AMP that compares the second voltage V₂ with a second reference voltage VREF₂ to output a second state voltage V_{SE2}. The second reference voltage VREF₂ is a maximum voltage in the reference voltage range. When the second voltage V₂ is higher than the second reference voltage VREF₂, the second state voltage VSE₂ has the first voltage level V+. When the second voltage V₂ is lower than the second reference voltage VREF₂, the second voltage V_{SE2} has the second voltage level V−.

The first and second reference voltages VREF₁ and VREF₂ may be adjusted to prevent a noise signal generated from the externally provided light L₂. Alternatively, the first and second reference voltages VREF₁ and VREF₂ may be also adjusted based on a sensitivity of the light sensing part 400.

A memory part 630 outputs a second control signal CS₂ that is outputted from the switching part 640 and corresponds to a previous frame. The memory part 630 stores a first control signal CS₁ that is outputted from the switching part 640 and corresponds to a present frame. The second control signal CS₂ is the on/off signal that turns on/off the light generating part 300, and corresponds to a state of the light generating part 300.

The switching part 640 receives the first state voltage V_{SE1} outputted from the first comparator 610, the second state voltage V_{SE2} outputted from the second comparator 620 and the second control signal CS₂ outputted from the memory part 630.

Table 1 represents digitalized signals including input and output signals of the switching part 640.

TABLE 1

| CS2 | D-low | D-high | CS1 |
|---|---|---|---|
| 0 | 0 | 0 | 0 |
| 0 | 0 | 1 | 0 |
| 0 | 1 | 0 | X |
| 0 | 1 | 1 | 1 |
| 1 | 0 | 0 | 0 |
| 1 | 0 | 1 | 0 |
| 1 | 1 | 0 | X |
| 1 | 1 | 1 | 1 |

Referring to Table 1, when the first and second control signals CS₁ and CS₂ are in a low state (0), the light generating part 300 is turned off. When the first and second control signals CS₁ and CS₂ are in a high state (1), the light generating part 300 is turned on.

A first state signal (D-low) is digitalized signal of the first state voltage V_{SE1}. That is, when the first state signal (D-low) is in the low state (0), the first state voltage V_{SE1} has the first voltage level (V+). In addition, when the first state signal (D-low) is in the high state (1), the first state voltage V_{SE1} has the second voltage level (V−).

A second state signal (D-high) is the digitalized signal of the second state voltage V_{SE2}. That is, when the second state signal (D-low) is in the low state (0), the second state voltage V_{SE2} has the first voltage level (V+). In addition, when the second state signal (D-high) is in the high state (1), the second state voltage V_{SE2} has the second voltage level (V−).

Referring again to the Table 1, when the second control signal CS₂, the first state signal (D-low) and the second state signal (D-low) are in the low state (0), the first control signal CS₁ outputted from the switching part 640 is in the low state (0) that is substantially same as the second control signal CS₂. Therefore, the light generating part 300 is also turned off during the present frame, when the second voltage V₂ outputted from the read-out part 500 is higher than the first and second reference voltages VREF₁ and VREF₂ and the light generating part 300 is turned off during the previous frame.

When the second control signal CS₂ and the first state signal (D-low) are in the low state (0) and the second state signal (D-high) is in the high state (1), the first control signal CS₁ outputted from the switching part 640 is in the low state (0) that is substantially same as the second control signal CS₂. Therefore, the light generating part 300 is also turned off during the present frame, when the second voltage V₂ is higher than the first reference voltage VREF₁ and lower than the second reference voltage VREF₂ and the light generating part 300 is turned off during the previous frame.

When the second control signal CS₂ is in the low state (0) and the first state signal (D-low) and the second state signal (D-high) are in the high state (1), the first control signal CS₁ outputted from the switching part 640 is in the high state (1) that is opposite to the second control signal CS₂. Therefore, the light generating part 300 is also turned on during the present frame, when the second voltage V₂ is higher than the first and second reference voltages VREF₁ and VREF₂ and the light generating part 300 is turned off during the previous frame.

When the second control signal CS₂ is in the high state (1) and the first state signal (D-low) and the second state signal (D-high) are in the low state (0), the first control signal CS₁ outputted from the switching part 640 is in the low state (0) that is opposite to the second control signal CS₂. Therefore, the light generating part 300 is turned off during the present frame.

When the second control signal CS₂ and the second state signal (D-high) are in the high state (1) and the first state signal (D-low) is in the low state (0), the first control signal CS₁ outputted from the switching part 640 is in the low state (0) that is opposite to the second control signal CS₂. Therefore, the light generating part 300 is turned on during the present frame.

When the second control signal CS₂, the first state signal (D-low) and the second state signal (D-high) are in the high state (1), the first control signal CS₁ outputted from the switching part 640 is in the high state (1) that is substantially same as the second control signal CS₂. Therefore, the light generating part 300 is turned on during the present frame.

When the first state signal (D-low) is in the high state (1), the second state (D-high) may not be in the low state (0).

FIG. 9 is a timing diagram showing an output signal of a second driving part according to an exemplary embodiment of the present invention. A horizontal axis represents a voltage and the on/off state of the light generating part 300.

Referring to FIG. 9, the first graph GRP₁ shows an operation of the light generating part 300 during a present frame in case that the light generating part 300 is turned off during a previous frame.

Referring to the first graph GRP₁ in the FIG. 9, the light generating part 300 is turned off during the present frame, when the light generating part 300 is turned off during the previous frame and the second voltage V₂ is lower than the second reference voltage VREF₂ during the present frame. In addition, the light generating part 300 is turned on, when the light generating part 300 is turned off during the previous frame and the second voltage V₂ is higher than the second reference voltage VREF₂ during the present frame.

Referring to FIG. 9, the second graph GRP₂ shows the operation of the light generating part 300 during the present frame in case that the light generating part 300 is turned on during the previous frame.

Referring to the second graph GRP₂ in the FIG. 9, the light generating part 300 is turned on, when the light generating part 300 is turned on during the previous frame and the second voltage V₂ is higher than the first reference voltage VREF₁ during the present frame. In addition, the light generating part 300 is turned off, when the light generating part 300 is turned off during the previous frame and the second voltage V₂ is lower than the second reference voltage VREF₁ during the present frame.

According to the present invention, the second driving part receives the second voltage corresponding to the externally provided light, and compares the second voltage with the first and second reference voltages that determine the reference voltage range to output the first control signal that operates the light generating part.

Therefore, the light generating part is turned on/off based on the amount of the externally provided light so as to reduce the power consumption of the display apparatus.

The second driving part also compares the second voltage with the reference voltages to output the first control signal based on the on/off state of the light generating part during the previous frame.

Furthermore, the number of the turning on/off is decreased to stabilize the operation of the light generating part by using the reference voltage range defined by the first and second reference voltages, although the amount of the externally provided light may be close to a predetermined reference amount, thereby increasing a lifetime of the light generating part.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

1. A display apparatus comprising:
a light generating part generating a first light based on a first control signal;
a first driving part outputting a panel driving signal;
a display panel disposed on the light generating part to receive the first light that is generated from the light generating part or a second light that is provided from an exterior to display an image based on the panel driving signal;
a sensing part disposed on the display panel to output a sensing signal based on the second light to the display panel; and
a second driving part disposed between the sensing part and the light generating part to compare a reference voltage range with the sensing signal to output the first control signal, the reference voltage range being determined based on a first reference voltage and a second reference voltage higher than the first reference voltage.

2. The display apparatus of claim 1, wherein the second driving part comprises:
a first comparator comparing the sensing signal with the first reference level to output a first state signal;
a second comparator comparing the sensing signal with the second reference level to output a second state signal; and
a switching part applying a first control signal to the light generating part based on the first and second state signals, the first control signal being in substantially same state or opposite state with respect to a second control signal corresponding to an on/off state of the light generating part.

3. The display apparatus of claim 2, wherein the second driving part stores the second control signal corresponding to the on/off state of the light generating part, and further comprises a memory part storing the first control signal outputted from the switching part that receives the second control signal.

4. The display apparatus of claim 2, wherein the first state signal is in a low state in case that the sensing signal is higher than the first reference level, the first state signal is in a high state in case that the sensing signal is lower than the first reference level, the second state signal is in the low state in case that the sensing signal is higher than the second reference level, and the second state signal is in the high state in case that the sensing signal is lower than the second reference level.

5. The display apparatus of claim 4, wherein the switching part outputs the first control signal that is substantially same as the second control signal, when the light generating part is turned off and the first and second state signals are in the low state.

6. The display apparatus of claim 4, wherein the switching part outputs the first control signal that is opposite to the second control signal, when the light generating part is turned off and the first and second state signals are in the high state.

7. The display apparatus of claim 4, wherein the switching part outputs the first control signal that is substantially same as the second control signal, when the light generating part is turned off and the first and second state signals are in the low state and the high state, respectively.

8. The display apparatus of claim 4, wherein the switching part outputs the first control signal that is opposite to the second control signal, when the light generating part is turned on and the first and second state signals are in the low state.

9. The display apparatus of claim 4, wherein the switching part outputs the first control signal that is substantially same as the second control signal, when the light generating part is turned on and the first and second state signals are in the high state.

10. The display apparatus of claim 4, wherein the switching part outputs the first control signal that is substantially same as the second control signal, when the light generating part is turned on and the first and second state signals are in the low state and the high state, respectively.

11. The display apparatus of claim 1, wherein the display panel comprises a display area and a peripheral area that is disposed at a position adjacent to the display area, and a plurality of gate lines, a plurality of data lines and the sensing part are disposed in the display area to display an image.

12. The display apparatus of claim 11, wherein a center of the display area corresponds a center of the display panel.

13. The display apparatus of claim 11, wherein a pixel transistor is disposed in the display area, and the pixel transistor comprises a first gate electrode electrically connected to one of the gate lines, a first source electrode electrically connected to one of the data lines and a first drain electrode electrically connected to a pixel electrode.

14. The display apparatus of claim 11, wherein the sensing part comprises a sensing transistor outputting the sensing signal based on the second light, and a first storage capacitor receiving a first voltage based on the sensing signal.

15. The display apparatus of claim 14, wherein the sensing transistor comprises amorphous silicon.

16. The display apparatus of claim 14, wherein the first driving part comprises a plurality of stages electrically connected to one another, and a gate driving integrated circuit outputting gate signals to the gate lines based on a first driving voltage, a second driving voltage and a start signal.

17. The display apparatus of claim 16, wherein the sensing transistor comprises a second drain electrode receiving the first driving voltage, a second gate electrode receiving the second driving voltage and a second source electrode outputting the sensing signal, and the first storage capacitor comprises a first electrode receiving the second driving voltage and a second electrode receiving the sensing signal.

18. The display apparatus of claim 16, further comprising a read-out part that reads the first voltage charged in the first storage capacitor.

19. The display apparatus of claim 18, wherein the read-out part further comprises:
a read-out transistor outputting a second voltage based on the first voltage and an output signal of a last stage of the stages; and
a second storage capacitor that receives the second voltage outputted from the switching transistor.

20. The display apparatus of claim 19, wherein the read-out transistor comprises a third drain electrode receiving the first voltage, a third gate electrode receiving the output signal of the last stage of the stages and a third source electrode outputting the second voltage, and the second storage capacitor comprises a third electrode receiving the second driving voltage and a fourth electrode receiving the second voltage.

21. The display apparatus of claim 16, wherein the gate driving integrated circuit is disposed in the peripheral area.

22. The display apparatus of claim 21, wherein the gate driving integrated circuit comprises amorphous silicon.

23. The display apparatus of claim 16, wherein the first driving part comprises one chip having the gate driving integrated circuit and a data driving integrated circuit outputting data signals to the data lines.

24. The display apparatus of claim 16, further comprising a reset part that initializes the sensing part at every predetermined interval.

25. The display apparatus of claim 24, wherein the reset part comprises a fourth gate electrode receiving the start signal, a fourth drain electrode receiving the first voltage and a fourth source electrode receiving the second driving voltage.

26. A method of driving a display apparatus comprising:
generating a first light based on a control signal;
outputting a panel driving signal;
receiving the first light or a second light that is provided from an exterior to display an image based on the panel driving signal;
outputting a sensing signal based on the second light; and
comparing the sensing signal with a first reference level and a second reference level higher than the first reference level, the first and second reference levels determining a voltage reference range to output the control signal.

27. The method of claim 26, wherein the image is displayed by using the first light during a present frame, when the image is displayed by using the first light during a previous frame and the sensing signal is lower than the second reference level.

28. The method of claim 26, wherein the image is displayed by using the second light during a present frame, when the image is displayed by using the first light during a previous frame and the sensing signal is higher than the second reference level.

29. The method of claim 26, wherein the image is displayed by using the first light during a present frame, when the image is displayed by using the second light during a previous frame and the sensing signal is lower than the first reference level.

30. The method of claim 26, wherein the image is displayed by using the second light during a present frame, when the image is displayed by using the second light during a previous frame and the sensing signal is higher than the first reference level.
